(19) United States
(12) Patent Application Publication
(10) Pub. No.: US 2023/0163652 A1
(43) Pub. Date: May 25, 2023

(54) STATOR CORE WITH CUFFED SLOT LINER

(71) Applicant: Ford Global Technologies, LLC, Dearborn, MI (US)

(72) Inventor: Singar Rathnam, Farmington Hills, MI (US)

(21) Appl. No.: 17/530,856

(22) Filed: Nov. 19, 2021

(51) Int. Cl. H02K 3/34; H02K 15/10

(52) U.S. Cl. CPC H02K 3/345; H02K 15/10

(57) ABSTRACT

An electric machine includes a stator core defining a plurality of slots, slot liners disposed within the slots and covering inner surfaces of the slots, and windings wound within and between the slots. Each of the slot liners has an end extending away from a face of the stator core and defining a flange that includes a rim in direct contact with the face and a terminating lip that is wider than the rim such that the rim is between the face and the terminating lip.

### TECHNICAL FIELD

This disclosure relates to electric machines.

### BACKGROUND

Electric machines are used to propel and brake vehicles. They often include wires wound within a stator core.

### SUMMARY

An electric machine includes a stator core defining a plurality of slots, slot liners disposed within the slots and configured to cover inner surfaces of the slots, and windings wound within and between the slots. Each of the slot liners has an end extending away from a face of the stator core and defining a flange that includes a rim in direct contact with the face and a terminating lip that is wider than the rim. The flange may taper from the lip to the rim. The flange may include a curved portion between the lip and the rim. Each of the slot liners may have a plurality of groves extending between opposite faces of the stator core. The grooves may be wavy. The electric machine may further include varnish around portions of the windings and within the grooves that mechanically retains the windings within the slot liners. The slot liners may comprise epoxy resin.

A method of making an electric machine includes positioning a support between a face of a stator core of the electric machine and a terminating lip of a flange of a slot liner that is within a slot of the stator core such that the support is underneath the terminating lip and adjacent to a rim of the slot liner, bending a wire extending out and away from the slot over the terminating lip and support, and removing the support from underneath the terminating lip. The method may further include filling the slot liner with varnish such that grooves defined by the slot liner take up some of the varnish.

A slot liner for a slot of an electric machine includes walls configured to cover inner surfaces of a slot of a stator core, and an end contiguous with the walls that is configured to extend away from a face of the stator core, and defining a flange. The flange includes a rim configured to be carried by and in direct contact with the face and a terminating lip that is wider than the rim. The flange may taper from the lip to the rim. The flange may further include a curved portion between the lip and the rim. The walls may define a plurality of groves extending between opposite ends thereof. The grooves may be wavy. A material of the slot liner may be epoxy resin.

### BRIEF DESCRIPTION OF THE DRAWINGS

FIG. 1 is a side view of portions of an electric machine.

FIG. 2 is a perspective view of the stator core, slots, and slot liners of the electric machine of FIG. 1.

FIG. 3 is a perspective view of one of the slot liners of FIG. 2.

FIG. 4 is a close-up view of the stator core, and one of the slots and slot liners of FIG. 2.

FIG. 5. is a close-up view of the electric machine of FIG. 1 during assembly.

FIG. 6 is a block diagram of a vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An electric machine includes a number of windings that are electrically driven to produce torque, and may be a three-phase machine that is driven by a three-phase inverter. The windings of the electric machine may be connected to the inverter in a delta or a wye configuration.

An electrified vehicle may include a plurality of electric machines. In some examples, one of the electric machines may function primarily as a motor and the other may function primarily as a generator. The motor may operate to convert electricity to mechanical power and the generator may operate to convert mechanical power to electricity. In other examples, an electric machine may be disposed at one or more wheels to provide propulsion and/or regeneration.

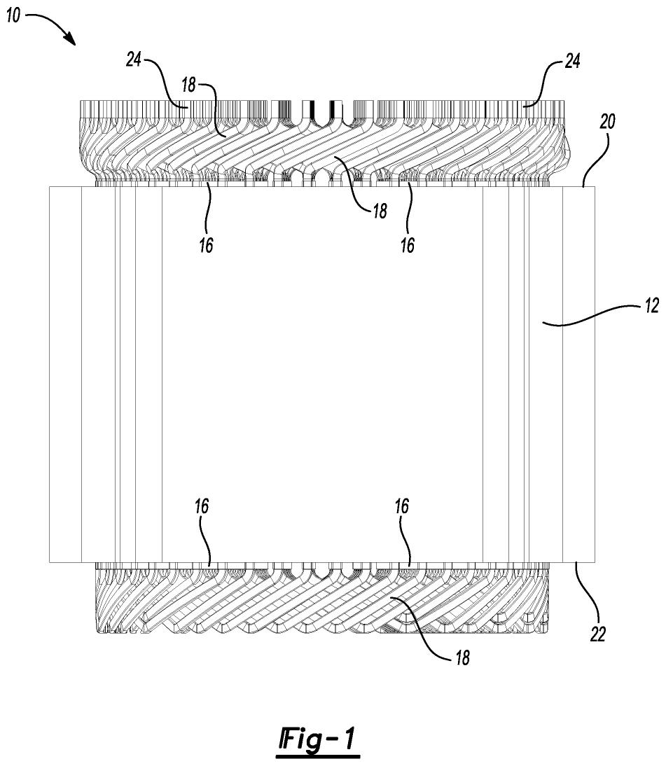

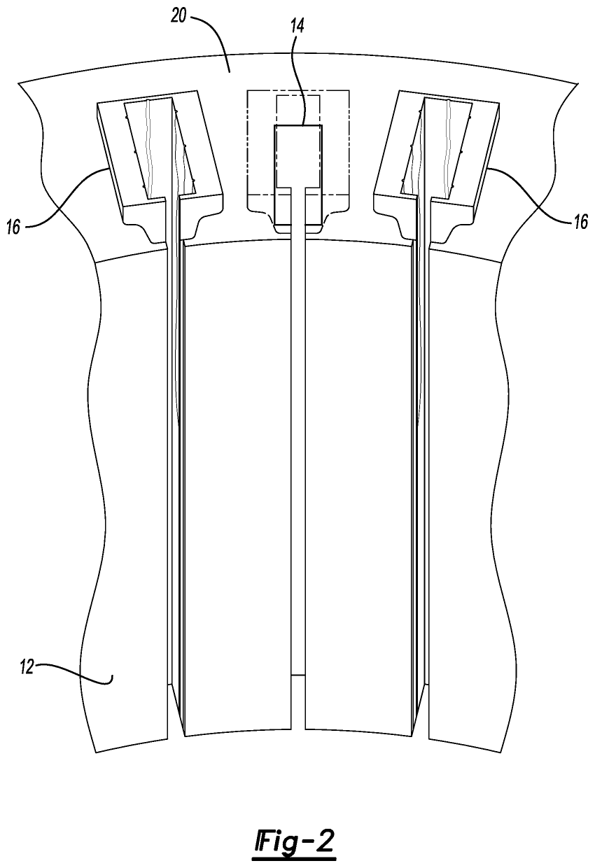

Referring to FIGS. 1 and 2, an electric machine 10 includes a stator core 12, slots 14, slot liners 16, and windings 18. The stator core 12 is formed by a stack of laminations, and defines a central cavity in which a rotor is sized for disposal and operation. A shaft may be operably connected to the rotor to receive drive torque resulting from electric machine output rotation of the rotor about its axis.

The slots 14, and slot liners 16 therein, are spaced around the stator core 12. The windings 18 are wound within the slots 14 and about the stator core 12 to generate an electromechanical field within the central cavity when energized to drive the rotor. The windings 18 may be routed throughout the slots 14 in a serpentine fashion to create one or more winding paths to transmit current though the stator core 12. Based on the arrangement of the windings 18, portions thereof may protrude from a twist side 20 and a crown side 22 of the stator core 12. The windings 18, in some examples, comprise copper hairpins that are inserted axially through the slots 14 such that end portions 24 thereof protrude beyond the twist side 20 as shown.

During electric machine assembly, the end portions 24 may initially be straight before being bent or twisted into the form shown with the assistance of various tools. Direct contact between such tools and the end portions 24 may result in loss of any coating on the end portions 24.

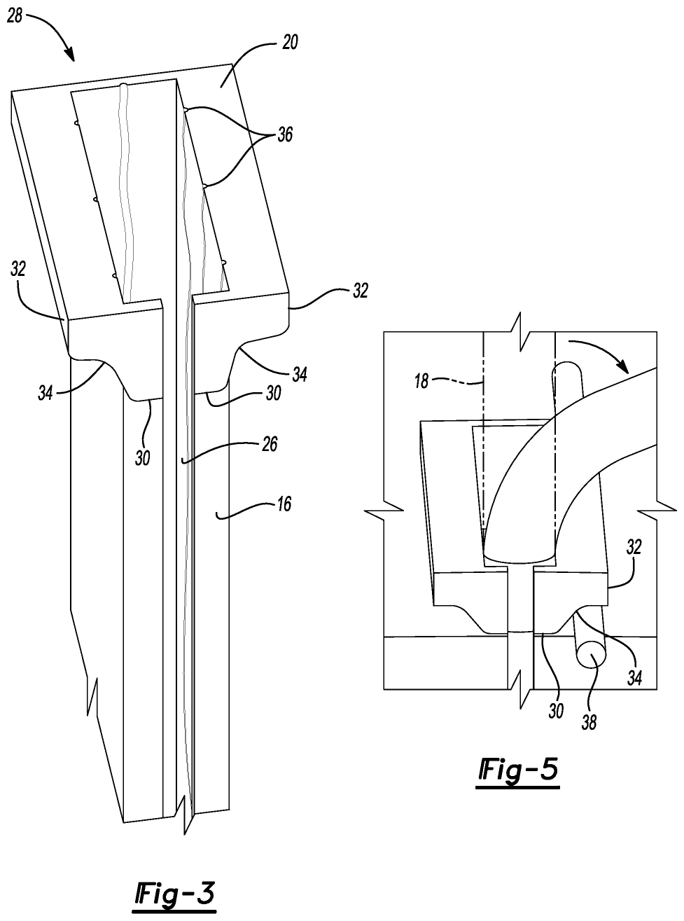

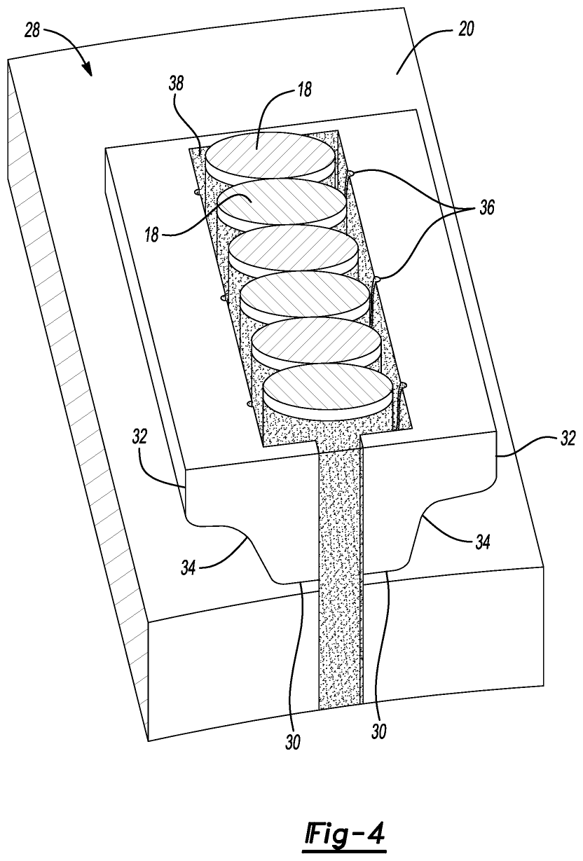

Referring to FIGS. 2, 3, and 4, the slot liners 16 have walls 26 that cover inner surfaces of the slots 14 to prevent direct contact between the stator core 12 and windings 18. Moreover, the slot liners 16 extend away from the twist and crown sides 20, 22 of the stator core 12. In this example, each of the slot liners 16 has, in cross-section, a generally rectangular-shape matching a shape of the slots 14 and defines an open portion 26 that the windings 18 may pass through when being wound onto the stator core 12.

Ends 28 of the slot liners 16 extending away from the twist face 20 of the stator core 12 each define a flange that includes a rim 30 in direct contact with and carried by the twist face 20 of the stator core 12, and a terminating lip 32 that is wider than the rim 30. The terminating lip 32 thus provides a platform over which the windings 18 extending out from the slots 14 may be bent. The flange further defines a concave or tapered portion 34 between the rim 30 and terminating lip 32, which further supports the platform provided by the terminating lip 32.

The walls 26, in this example, include optional grooves or hairline crevices 36 that extend between opposite ends of the slot liner 16. The grooves 36 may be straight, wavy, or have any other type of desired configuration to reduce insertion forces during winding and provide retention cavities for varnish 38 filling the slot liner 16 during assembly.

The slot liners 16 may be over-molded onto the stator core 12 in epoxy resin or similar materials, and the walls 26 may have a thickness in the range, for example, of 0.2 mm to 0.3 mm.

Referring to FIG. 5, a support tool 40 is positioned under the terminating lip 32 and adjacent to the rim 30 of one of the slot liners 16. The windings 18 extending from within and away from the slot 14 can then be bent over the terminating lip 32 and support tool 40 without contacting the support tool 40. Once complete, the varnish 38 is then added to fill the slots 14, surround the windings 18 contained therein, and is taken up by the grooves 36 via capillary action. The varnish 38, once cured, thus mechanically retains the windings 18 within the slots 14.

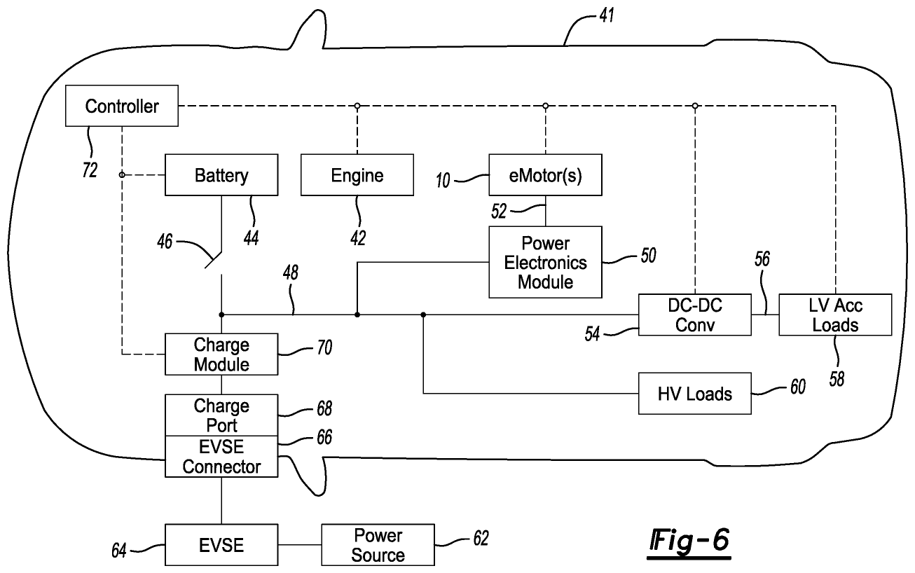

The electric machine 10 may be used within the context of an automotive vehicle as suggested above. Referring to FIG. 6, a hybrid-electric vehicle 41 includes an electrified propulsion system having one or more the electric machines 10 mechanically coupled to a hybrid transmission (not shown). The electric machines 10 may be capable of operating as a motor or a generator. In addition, the hybrid transmission is mechanically coupled to an internal combustion engine 42. The electric machines 10 are arranged to provide propulsion torque as well as slowing torque capability either while the engine 42 is operated or turned off. The electric machines 10 are capable of operating as generators to provide fuel economy benefits by recovering energy that would normally be lost as heat in a friction braking system. The electric machines 10 may additionally impart a reaction torque against the engine output torque to generate electricity for recharging a traction battery while the vehicle 41 is operating. The electric machines 10 may further reduce vehicle emissions by allowing the engine 42 to operate near the most efficient speed and torque ranges. When the engine 42 is off, the vehicle 41 may be operated in an electric-only drive mode using the electric machines 10 as the sole source of propulsion. The hybrid transmission is also mechanically coupled to road wheels to output torque from the electric machines 10 and/or combustion engine 42.

A traction battery or battery pack 44 stores energy that can be used to power the electric machines 10. The battery pack 44 provides a high-voltage direct current (DC) output. One or more contactors 46 may isolate the traction battery 44 from a DC high-voltage bus 48 when opened and couple the traction battery 44 to the DC high-voltage bus 48 when closed. The traction battery 44 is electrically coupled to one or more power electronics modules 50 via the DC high-voltage bus 48. The power electronics module 50 is also electrically coupled to the electric machines 10 and provides the ability to bi-directionally transfer energy between an alternating current (AC) high-voltage bus 52 and the electric machines 10. In some examples, the traction battery 44 may provide DC while the electric machines 10 operate using three-phase AC. The power electronics module 50 may convert the DC to three-phase AC to operate the electric machines 10. In regenerative mode, the power electronics module 50 may convert the three-phase AC current output from the electric machines 10 acting as generators to DC compatible with the traction battery 44. The description herein is equally applicable to an all-electric vehicle without a combustion engine.

In addition to providing energy for propulsion, the traction battery 44 may provide energy for other vehicle electrical systems. The vehicle 41 may include a DC/DC converter module 54 that is electrically coupled to the high-voltage bus 48. The DC/DC converter module 54 may be electrically coupled to a low-voltage bus 56. The DC/DC converter module 54 may convert the high-voltage DC output of the traction battery 44 to a low-voltage DC supply that is compatible with low-voltage vehicle loads 58. High-voltage loads 60 are also electrically coupled to the high-voltage bus 48.

The traction battery 44 may be recharged by an off-board power source 62, which may be a connection to an electrical outlet. The external power source 62 may be electrically coupled to a charger or another type of electric vehicle supply equipment (EVSE) 64. The off-board power source 62 may be an electrical power distribution network or grid as provided by an electric utility company. The EVSE 64 provides circuitry and controls to regulate and manage the transfer of energy between the power source 62 and the vehicle 41. The off-board power source 62 may provide DC or AC electric power to the EVSE 64. The EVSE 64 is outfitted with a connector 66 that mates with a charge port 68 of the vehicle 41. The charge port is electrically coupled with a charge module 70 that can be electrically coupled with the traction battery 44 via the one or more contactors 46.

The various components discussed may have one or more associated controllers to control, monitor, and coordinate the operation of the components. The controllers may communicate via a serial bus (e.g., Controller Area Network (CAN)) or via discrete conductors. In addition, a vehicle system controller 72 may be provided to coordinate the operation of the various components such as governing electrical flow to and from the one or more electric machines 10.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric machine comprising:
a stator core defining a plurality of slots;
slot liners disposed within the slots and configured to cover inner surfaces of the slots, each of the slot liners having an end extending away from a face of the stator core and defining a flange that includes a rim in direct contact with the face and a terminating lip that is wider than the rim such that the rim is between the face and the terminating lip; and
windings wound within and between the slots.

2. The electric machine of claim 1, wherein the flange tapers from the lip to the rim.

3. The electric machine of claim 1, wherein the flange further includes a curved portion between the lip and the rim.

4. The electric machine of claim 1, wherein each of the slot liners has a plurality of groves extending between opposite faces of the stator core.

5. The electric machine of claim 4, wherein the grooves are wavy.

6. The electric machine of claim 4 further comprising varnish around portions of the windings and within the grooves configured to mechanically retain the windings within the slot liners.

7. The electric machine of claim 1, wherein the slot liners comprise epoxy resin.

8. A method of making an electric machine comprising:
positioning a support between a face of a stator core of the electric machine and a terminating lip of a flange of a slot liner that is within a slot of the stator core such that the support is underneath the terminating lip and adjacent to a rim of the slot liner;
bending a wire extending out and away from the slot over the terminating lip and support; and
removing the support from underneath the terminating lip.

9. The method of claim 8 further comprising filling the slot liner with varnish such that grooves defined by the slot liner take up some of the varnish.

10. The method of claim 9, wherein the grooves are wavy.

11. The method of claim 9, wherein the flange tapers from the terminating lip to the rim.

12. A slot liner for a slot of an electric machine comprising:
walls configured to cover inner surfaces of a slot of a stator core; and
an end contiguous with the walls, configured to extend away from a face of the stator core, and defining a flange that includes a rim configured to be carried by and in direct contact with the face and a terminating lip that is wider than the rim.

13. The slot liner of claim 12, wherein the flange tapers from the lip to the rim.

14. The slot liner of claim 12, wherein the flange further includes a curved portion between the lip and the rim.

15. The slot liner of claim 12, wherein the walls define a plurality of groves extending between opposite ends thereof.

16. The slot liner of claim 15, wherein the grooves are wavy.

17. The slot liner of claim 12, wherein a material of the slot liner is epoxy resin.
